(19) United States
(12) Patent Application Publication
(10) Pub. No.: US 2017/0310993 A1
(43) Pub. Date: Oct. 26, 2017

(54) MOVEMENT INFORMATION COMPRESSION METHOD AND DEVICE FOR 3D VIDEO CODING

(71) Applicant: LG ELECTRONICS INC., Seoul (KR)

(72) Inventors: Junghak NAM, Seoul (KR); Sehoon YEA, Seoul (KR); Jungdong SEO, Seoul (KR); Sunmi YOO, Seoul (KR)

(21) Appl. No.: 15/517,712

(22) PCT Filed: Oct. 6, 2015
(86) PCT No.: PCT/KR2015/010554

§ 371 Date: Apr. 7, 2017

Related U.S. Application Data
(60) Provisional application No. 62/061,151, filed on Oct. 8, 2014.

(51) Int. Cl. H04N 19/597; H04N 19/513; H04N 19/44

(52) U.S. Cl. CPC H04N 19/597; H04N 19/44; H04N 19/513

(57) ABSTRACT

The present invention relates to 3D video coding device and method. A decoding method according to the present invention provides a 3D video decoding method. A decoding method comprises the steps of: deriving a disparity vector with respect to a current block; deriving the location of a corresponding sample on a reference view on the basis of the disparity vector; deriving the location of a reference sample on the basis of the location of the corresponding sample; and deriving movement information of a prediction block that covers the location of the reference sample. According to the present invention, when a corresponding block in a reference view is derived by means of a disparity vector, movement information of the corresponding block can be derived in accordance with movement information compression, a buffer load of an encoder and a decoder can be reduced, and coding efficiency can be enhanced by having the amount of information being processed reduced.

### CROSS-REFERENCE TO RELATED APPLICATIONS

This application is the National Stage filing under 35 U.S.C. 371 of International Application No. PCT/KR2015/010554, filed on Oct. 6, 2015, which claims the benefit of U.S. Provisional Application No. 62/061,151 filed on Oct. 8, 2014, the contents of which are all hereby incorporated by reference herein in their entirety.

### BACKGROUND OF THE INVENTION

### Field of the Invention

The present invention relates to video coding, and more particularly, to a method and apparatus for utilizing motion information by compressing and storing it in 3 dimensional (3D) video coding.

### Related Art

In recent years, demands for a high-resolution and high-quality video have increased in various fields of applications. However, the higher the resolution and quality video data becomes, the greater the amount of video data becomes.

Accordingly, when video data is transferred using media such as existing wired or wireless broadband lines or video data is stored in existing storage media, the transfer cost and the storage cost thereof increase. High-efficiency video compressing techniques can be used to effectively transfer, store, and reproduce high-resolution and high-quality video data.

On the other hand, with realization of capability of processing a high-resolution/high-capacity video, digital broadcast services using a 3D video have attracted attention as a next-generation broadcast service. A 3D video can provide a sense of realism and a sense of immersion using multi-view channels.

A 3D video can be used in various fields such as free viewpoint video (FVV), free viewpoint TV (FTV), 3DTV, surveillance, and home entertainments.

Unlike a single-view video, a 3D video using multi-views have a high correlation between views having the same picture order count (POC). Since the same scene is shot with multiple neighboring cameras, that is, multiple views, multi-view videos have almost the same information except for a parallax and a slight illumination difference and thus difference views have a high correlation therebetween.

Accordingly, the correlation between different views can be considered for coding/decoding 3D video, and information need for coding and/or decoding of a current view can be obtained. For example, a current block to be decoded in a current view can be predicted or decoded with reference to a block in another view.

Each inter-view picture may be split into blocks having different sizes, and storing of all related information in a reference picture of another view including a reference block to perform coding on a current block is a burden on a buffer load of an encoder and a decoder. Accordingly, there is a need to compress related information such as motion information or the like.

### SUMMARY OF THE INVENTION

The present invention provides a method and apparatus for compressing motion information in 3 dimensional (3D) video coding.

The present invention provides a method and apparatus for compressing motion information for each of blocks in a reference picture of a reference view.

The present invention is for deriving motion information on a reference block by considering motion information compression when coding a current block.

The present invention is for deriving motion information on a corresponding block by considering motion information compression when the corresponding block in a reference view is derived by using a disparity vector.

The present invention provides a method and apparatus for deriving motion information of a corresponding block when an inter-view merge candidate or a residual prediction scheme is used for a current block.

According to an embodiment of the present invention, a 3D video decoding method is provided. The decoding method includes: deriving a disparity vector for a current block; deriving a position of a corresponding sample on a reference view on the basis of the disparity vector; deriving a position of a reference sample on the basis of the position of the corresponding sample; and deriving motion information of a prediction block which covers the position of the reference sample.

Herein, inter-view prediction or residual prediction may be performed on the current block on the basis of the derived motion information.

The position of the corresponding sample may be derived as a top-left position of a corresponding block determined based on the position of the current block and the disparity vector

The position of the corresponding sample may be derived as a center position of a corresponding block determined based on the position of the current block and the disparity vector.

The position of the reference sample may be a top-left sample position of a motion compression unit block including the corresponding sample.

The position of the reference sample may be derived by performing a shift operation based on the position of the corresponding sample.

According to another embodiment of the present invention, a 3D video decoding device is provided. The decoding device includes a decoder for decoding video information and a predictor for deriving a disparity vector for a current block, determining a position of a corresponding sample on a reference view on the basis of the disparity vector, deriving a position of a reference sample on the basis of the position of the corresponding sample, and deriving motion information of a prediction block covering the position of the reference sample.

According to the present invention, motion information can be compressed and stored in 3D video coding. Therefore, if a corresponding block is derived in a reference view by using a disparity vector, motion information of the corresponding block may be derived by considering motion information compression, a buffer load of an encoder and a decoder can be decreased, and coding efficiency can be improved by decreasing an amount of information to be pressed.

### BRIEF DESCRIPTION OF THE DRAWINGS

FIG. 1 briefly illustrates a 3 dimensional (3D) video encoding and decoding process to which the present invention is applicable.

FIG. 2 briefly illustrates a structure of a video encoding device to which the present invention is applicable.

FIG. 3 briefly illustrates a structure of a video decoding device to which the present invention is applicable.

FIG. 4 briefly illustrates an inter-view motion prediction scheme.

FIG. 5 briefly illustrates a residual prediction scheme.

FIG. 6 briefly illustrates a positional relation between a current block and a corresponding block.

FIG. 7 is a flowchart briefly showing a 3D video coding method according to an embodiment of the present invention.

### DESCRIPTION OF EXEMPLARY EMBODIMENTS

The invention may be variously modified in various forms and may have various embodiments, and specific embodiments thereof will be illustrated in the drawings and described in detail. However, these embodiments are not intended for limiting the invention. Terms used in the below description are used to merely describe specific embodiments, but are not intended for limiting the technical spirit of the invention. An expression of a singular number includes an expression of a plural number, so long as it is clearly read differently. Terms such as “include” and “have” in this description are intended for indicating that features, numbers, steps, operations, elements, components, or combinations thereof used in the below description exist, and it should be thus understood that the possibility of existence or addition of one or more different features, numbers, steps, operations, elements, components, or combinations thereof is not excluded.

On the other hand, elements of the drawings described in the invention are independently drawn for the purpose of convenience of explanation on different specific functions, and do not mean that the elements are embodied by independent hardware or independent software. For example, two or more elements out of the elements may be combined to form a single element, or one element may be split into plural elements. Embodiments in which the elements are combined and/or split belong to the scope of the invention without departing from the concept of the invention.

Hereinafter, embodiments of the present invention will be described in detail with reference to the accompanying drawings. In addition, like reference numerals are used to indicate like elements throughout the drawings, and the same descriptions on the like elements will be omitted.

In the present specification, a picture generally means a unit representing one image of a specific time zone, and a slice is a unit constituting a part of the picture in coding. One picture may consist of a plurality of slices. Optionally, the picture and the slice may be used interchangeably.

A pixel or a pe1 may mean a minimum unit constituting one picture (or image). Further, a ‘sample’ may be used as a term representing a value of a specific pixel. The sample may generally indicate a value of the pixel, may represent only a pixel value of a luma component, and may represent only a pixel value of a chroma component.

A unit indicates a basic unit of image processing. The unit may include at least one of a specific area and information related to the area. Optionally, the unit may be mixed with terms such as a block, an area, or the like. In a typical case, an M·N block may represent a set of samples or transform coefficients arranged in M columns and N rows.

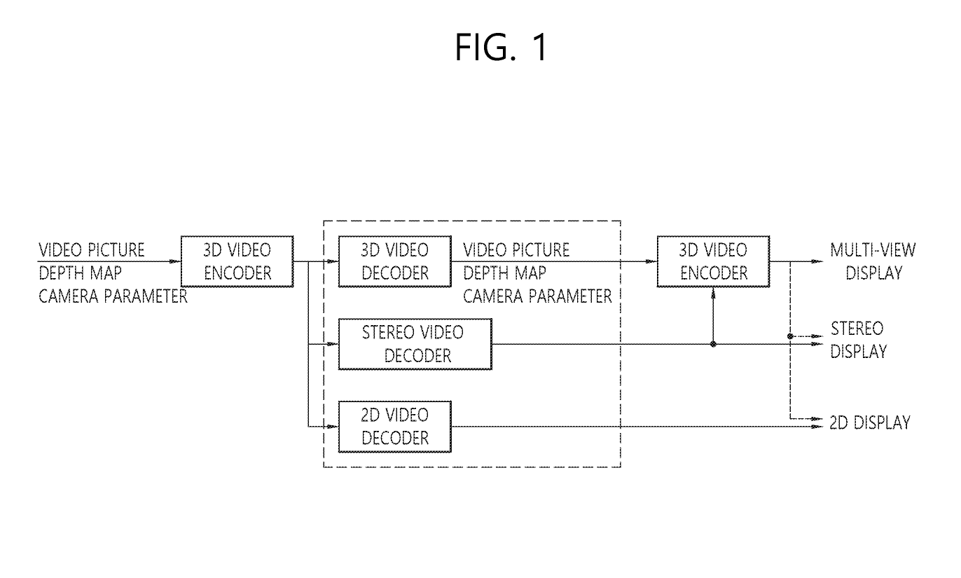

FIG. 1 briefly illustrates a 3 dimensional (3D) video encoding and decoding process to which the present invention is applicable.

Referring to FIG. 1, a 3D video encoder may encode a video picture, a depth map, and a camera parameter to output a bitstream.

The depth map may be constructed of distance information (depth information) between a camera and a subject with respect to a picture of a corresponding video picture (texture picture). For example, the depth map may be an image obtained by normalizing depth information according to a bit depth. In this case, the depth map may be constructed of depth information recorded without a color difference representation. The depth map may be called a depth map picture or a depth picture.

In general, a distance to the subject and a disparity are inverse proportional to each other. Therefore, disparity information indicating an inter-view correlation may be derived from the depth information of the depth map by using the camera parameter.

A bitstream including the depth map and the camera parameter together with a typical color image, i.e., a video picture (texture picture), may be transmitted to a decoder through a network or a storage medium.

From a decoder side, the bitstream may be received to reconstruct a video. If a 3D video decoder is used in the decoder side, the 3D video decoder may decode the video picture, the depth map, and the camera parameter from the bitstream. Views required for a multi-view display may be synthesized on the basis of the decoded video picture, depth map, and camera parameter. In this case, if a display in use is a stereo display, a 3D image may be displayed by using pictures for two views among reconstructed multi-views.

If a stereo video decoder is used, the stereo video decoder may reconstruct two pictures to be incident to both eyes from the bitstream. In a stereo display, a stereoscopic image may be displayed by using a view difference or disparity of a left image which is incident to a left eye and a right image which is incident to a right eye. When a multi-view display is used together with the stereo video decoder, a multi-view may be displayed by generating different views on the basis of reconstructed two pictures.

If a 2D decoder is used, a 2D image may be reconstructed to output the image to a 2D display. If the 2D display is used but the 3D video decoder or the stereo video decoder is used as the decoder, one of the reconstructed images may be output to the 2D display.

In the structure of FIG. 1, a view synthesis may be performed in a decoder side or may be performed in a display side. Further, the decoder and the display may be one device or may be separate devices.

Although it is described for convenience in FIG. 1 that the 3D video decoder and the stereo video decoder and the 2D video decoder are separate decoders, one decoding device may perform all of the 3D video decoding, the stereo video decoding, and the 2D video decoding. Further, the 3D video decoding device may perform the 3D video decoding, the stereo video decoding device may perform the stereo video decoding, and the 2D video decoding device may perform the 2D video decoding. Further, the multi-view display may output the 2D video or may output the stereo video.

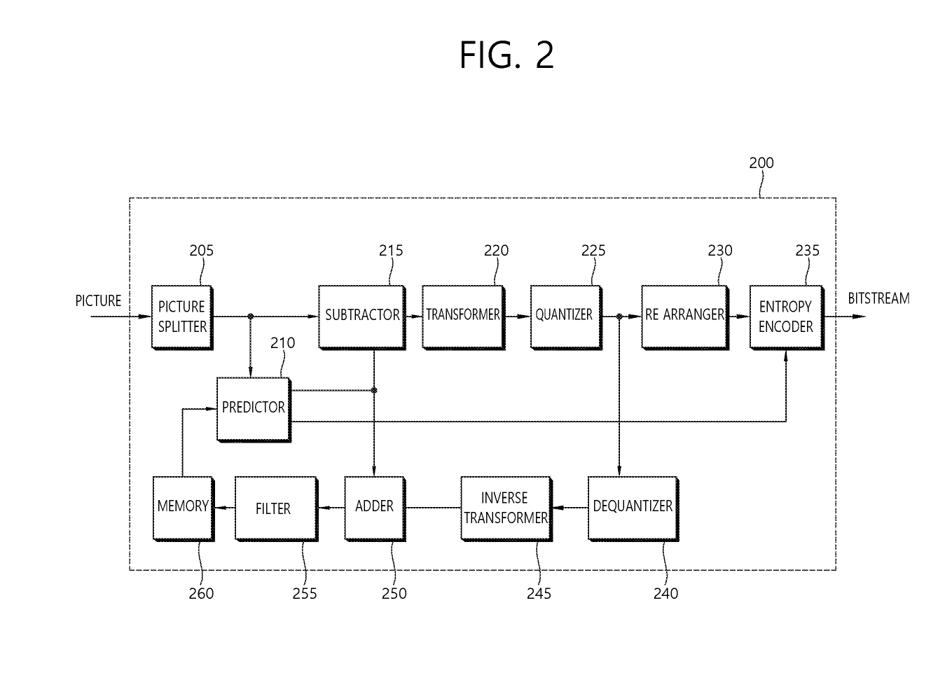

FIG. 2 briefly illustrates a structure of a video encoding device to which the present invention is applicable.

Referring to FIG. 2, a video encoding device 200 includes a picture splitter 205, a predictor 210, a subtractor 215, a transformer 220, a quantizer 225, a re-arranger 230, an entropy encoder 235, a dequantizer 240, an inverse transformer 245, an adder 250, a filter 255, and a memory 260.

The picture splitter 205 may split an input picture into at least one processing unit block. In this case, the processing unit block may be a coding unit block, a prediction unit block, or a transform unit block. As a unit block of coding, the coding unit block may be split from a largest coding unit block according to a quad-tree structure. As a block partitioned from the coding unit block, the prediction unit block may be a unit block of sample prediction. In this case, the prediction unit block may be divided into sub blocks. The transform unit block may be split from the coding unit block according to the quad-tree structure, and may be a unit block for deriving according to a transform coefficient or a unit block for deriving a residual signal from the transform coefficient.

Hereinafter, the coding unit block may be called a coding block (CB) or a coding unit (CU), the prediction unit block may be called a prediction block (PB) or a prediction unit (PU), and the transform unit block may be called a transform block (TB) or a transform unit (TU).

The prediction block or the prediction unit may mean a specific area having a block shape in a picture, and may include an array of a prediction sample. Further, the transform block or the transform unit may mean a specific area having a block shape in a picture, and may include a transform coefficient or an array of a residual sample.

The predictor 210 may perform prediction on a processing target block (hereinafter, a current block), and may generate a prediction block including prediction samples for the current block. A unit of prediction performed in the predictor 210 may be a coding block, or may be a transform block, or may be a prediction block.

The predictor 210 may determine whether intra prediction is applied or inter prediction is applied to the current block. For example, the predictor 210 may determine whether the intra prediction or the inter prediction is applied in unit of CU.

In case of the intra prediction, the predictor 210 may derive a prediction sample for the current block on the basis of a reference sample outside the current block in a picture to which the current block belongs (hereinafter, a current picture). In this case, the predictor 210 may derive the prediction sample on the basis of an average or interpolation of neighboring reference samples of the current block (case (i)), or may derive the prediction sample on the basis of a reference sample existing in a specific (prediction) direction as to a prediction sample among the neighboring reference samples of the current block (case (ii)). The case (i) may be called a non-directional mode, and the case (ii) may be called a directional mode. The predictor 210 may determine the prediction mode to be applied to the current block by using the prediction mode applied to the neighboring block.

In case of the inter prediction, the predictor 210 may derive the prediction sample for the current block on the basis of a sample specified by a motion vector on a reference picture. The predictor 210 may derive the prediction sample for the current block by applying any one of a skip mode, a merge mode, and a motion vector prediction (MVP) mode. In case of the skip mode and the merge mode, the predictor 210 may use motion information of the neighboring block as motion information of the current block. In case of the skip mode, unlike in the merge mode, a difference (residual) between the prediction sample and an original sample is not transmitted. In case of the MVP mode, a motion vector of the neighboring block is used as a motion vector predictor and thus is used as a motion vector predictor of the current block to derive a motion vector of the current block.

In case of the inter prediction, the neighboring block includes a spatial neighboring block existing in the current picture and a temporal neighboring block existing in the reference picture. The reference picture including the temporal neighboring block may also be called a collocated picture (colPic). Motion information may include the motion vector and the reference picture. If the motion information of the temporal neighboring block is used in the skip mode and the merge mode, a top picture on a reference picture list may be used as the reference picture.

A multi-view may be divided into an independent view and a dependent view. In case of encoding for the independent view, the predictor 210 may perform not only inter prediction but also inter-view prediction.

The predictor 210 may configure the reference picture list by including pictures of different views. For the inter-view prediction, the predictor 210 may derive a disparity vector. Unlike in the motion vector which specifies a block corresponding to the current block in a different picture in the current view, the disparity vector may specify a block corresponding to the current block in another view of the same access unit (AU) as the current picture. In the multi-view, for example, the AU may include video pictures and depth maps corresponding to the same time instance. Herein, the AU may mean a set of pictures having the same picture order count (POC). The POC corresponds to a display order, and may be distinguished from a coding order.

The predictor 210 may specify a depth block in a depth view on the basis of the disparity vector, and may perform merge list configuration, an inter-view motion prediction, residual prediction, illumination compensation (IC), view synthesis, or the like.

The disparity vector for the current block may be derived from a depth value by using a camera parameter, or may be derived from a motion vector or disparity vector of a neighboring block in a current or different view.

For example, the predictor 210 may add, to the merging candidate list, an inter-view merging candidate (IvMC) corresponding to temporal motion information of a reference view, an inter-view disparity vector candidate (IvDC) corresponding to a disparity vector, a shifted IvMC derived by a shift of a disparity vector, a texture merging candidate (T) derived from a corresponding texture picture when a current block is a block on a depth map, a disparity derived merging candidate (D) derived by using a disparity from the texture merging candidate, a view synthesis prediction candidate (VSP) derived on the basis of view synthesis, or the like.

In this case, the number of candidates included in the merging candidate list to be applied to the dependent view may be limited to a specific value.

Further, the predictor 210 may predict the motion vector of the current block on the basis of the disparity vector by applying the inter-view motion vector prediction. In this case, the predictor 210 may derive the disparity vector on the basis of a conversion of a largest depth value in a corresponding depth block. When a position of a reference sample in a reference view is specified by adding the disparity vector to a sample position of the current block in the reference view, a block including the reference sample may be used as a reference block. The predictor 210 may use the motion vector of the reference block as a candidate motion parameter of the current block or a motion vector predictor candidate, and may use the disparity vector as a candidate disparity vector for a disparity compensated prediction (DCP).

The subtractor 215 generates a residual sample which is a difference between an original sample and a prediction sample. If the skip mode is applied, the residual sample may not be generated as described above.

The transformer 220 transforms a residual sample in unit of a transform block to generate a transform coefficient. The quantizer 225 may quantize the transform coefficients to generate a quantized transform coefficient.

The re-arranger 230 re-arranges the quantized transform coefficients. The re-arranger 230 may re-arrange the quantized transform coefficients having a block shape in a 1D vector form by using a scanning method.

The entropy encoder 235 may perform entropy-encoding on the quantized transform coefficients. The entropy encoding may include an encoding method, for example, an exponential Golomb, a context-adaptive variable length coding (CAVLC), a context-adaptive binary arithmetic coding (CABAC), or the like. The entropy encoder 235 may perform encoding together or separately on information (e.g., a syntax element value or the like) required for video reconstruction in addition to the quantized transform coefficients. The entropy-encoded information may be transmitted or stored in unit of a network abstraction layer (NAL) in a bitstream form.

The adder 250 adds the residual sample and the prediction sample to reconstruct the picture. The residual sample and the prediction sample may be added in unit of blocks to generate a reconstruction block. Although it is described herein that the adder 250 is configured separately, the adder 250 may be a part of the predictor 210.

The filter 255 may apply deblocking filtering and/or a sample adaptive offset to the reconstructed picture. An artifact of a block boundary in the reconstructed picture or a distortion in a quantization process may be corrected through the deblocking filtering and/or the sample adaptive offset. The sample adaptive offset may be applied in unit of samples, and may be applied after a process of the deblocking filtering is complete.

The memory 260 may store the reconstructed picture or information required for encoding/decoding. For example, the memory 260 may store (reference) pictures used in inter prediction/inter-view prediction. In this case, pictures used in the inter prediction/inter-view prediction may be designated by a reference picture set or a reference picture list.

Although it is described herein that one encoding device encodes an independent view and a dependent view, this is for convenience of explanation. Thus, a separate encoding device may be configured for each view, or a separate internal module (e.g., a prediction module for each view) may be configured for each view.

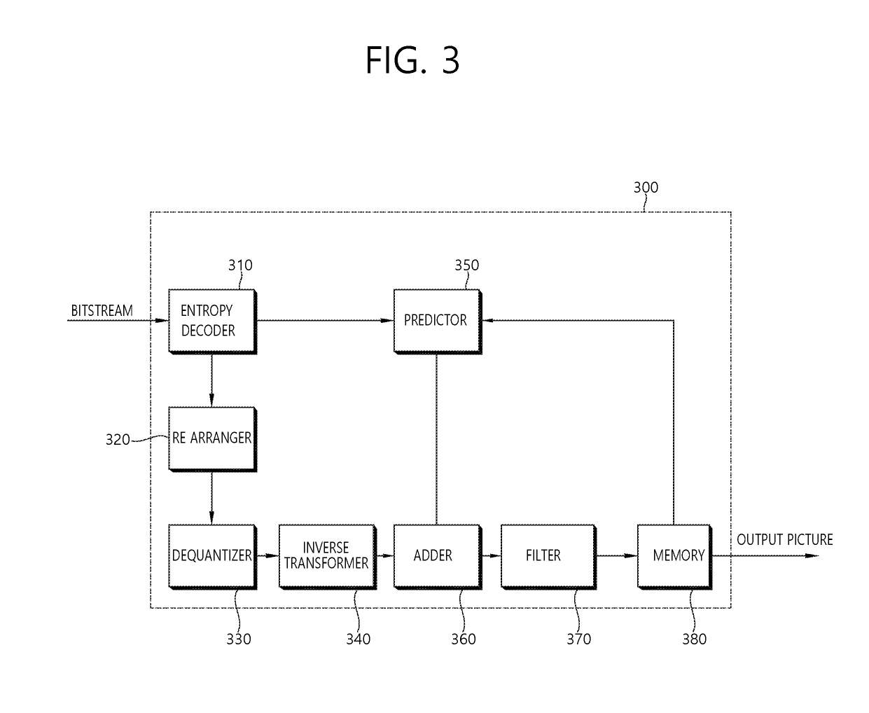

FIG. 3 briefly illustrates a structure of a video decoding device to which the present invention is applicable.

Referring to FIG. 3, a video decoding device 300 includes an entropy decoder 310, a re-arranger 320, a dequantizer 330, an inverse transformer 340, a predictor 350, an adder 360, a filter 370, and a memory 380.

When a bitstream including video information is input, the video decoding device 300 may reconstruct a video in association with a process by which video information is processed in the video encoding device.

For example, the video decoding device 300 may perform video decoding by using a processing unit applied in the video encoding device. Therefore, the processing unit block of video decoding may be a coding unit block, a prediction unit block, or a transform unit block. As a unit block of decoding, the coding unit block may be split according to a quad tree structure from a largest coding unit block. As a block partitioned from the coding unit block, the prediction unit block may be a unit block of sample prediction. In this case, the prediction unit block may be divided into sub blocks. As a coding unit block, the transform unit block may be split according to the quad tree structure, and may be a unit block for deriving a transform coefficient or a unit block for deriving a residual signal from the transform coefficient.

The entropy decoder 310 may parse the bitstream to output information required for video reconstruction or picture reconstruction. For example, the entropy decoder 310 may decode information in the bitstream on the basis of a coding method such as exponential Golomb encoding, CAVLC, CABAC, or the like, and may output a value of a syntax element required for video reconstruction and a quantized value of a transform coefficient regarding a residual.

If a plurality of views are processed to reproduce a 3D video, the bitstream may be input for each view. Alternatively, information regarding each view may be multiplexed in the bitstream. In this case, the entropy decoder 310 may de-multiplex the bitstream to parse it for each view.

The re-arranger 320 may re-arrange quantized transform coefficients in a form of a 2D block. The re-arranger 320 may perform re-arrangement in association with coefficient scanning performed in an encoding device.

The dequantizer 330 may de-quantize the quantized transform coefficients on the basis of a (de)quantization parameter to output a transform coefficient. In this case, information for deriving a quantization parameter may be signaled from the encoding device.

The inverse transformer 340 may inverse-transform the transform coefficients to derive residual samples.

The predictor 350 may perform prediction on a current block, and may generate a prediction block including prediction samples for the current block. A unit of prediction performed in the predictor 350 may be a coding block or may be a transform block or may be a prediction block.

The predictor 350 may determine whether to apply intra prediction or inter prediction. In this case, a unit for determining which one will be used between the intra prediction and the inter prediction may be different from a unit for generating a prediction sample. In addition, a unit for generating the prediction sample may also be different in the inter prediction and the intra prediction. For example, which one will be applied between the inter prediction and the intra prediction may be determined in unit of CU. Further, for example, in the inter prediction, the prediction sample may be generated by determining the prediction mode in unit of PU, and in the intra prediction, the prediction sample may be generated in unit of TU by determining the prediction mode in unit of PU.

In case of the intra prediction, the predictor 350 may derive a prediction sample for a current block on the basis of a neighboring reference sample in a current picture. The predictor 350 may derive the prediction sample for the current block by applying a directional mode or a non-directional mode on the basis of the neighboring reference sample of the current block. In this case, a prediction mode to be applied to the current block may be determined by using an intra prediction mode of a neighboring block.

In case of the inter prediction, the predictor 350 may derive the prediction sample for the current block on the basis of a sample specified on a reference picture by a motion vector on the reference picture. The predictor 350 may derive the prediction sample for the current block by applying any one of a skip mode, a merge mode, and an MVP mode.

In case of the skip mode and the merge mode, motion information of the neighboring block may be used as motion information of the current block. In this case, the neighboring block may include a spatial neighboring block and a temporal neighboring block.

The predictor 350 may construct a merging candidate list by using motion information of an available neighboring block, and may use information indicated by a merge index on the merging candidate list as a motion vector of the current block. The merge index may be signaled from the encoding device. The motion information may include the motion vector and the reference picture. When motion information of the temporal neighboring block is used in the skip mode and the merge mode, a highest picture on the reference picture list may be used as the reference picture.

In case of the skip mode, unlike in the merge mode, a difference (residual) between the prediction sample and the original sample is not transmitted.

In case of the MVP mode, the motion vector of the current block may be derived by using the motion vector of the neighboring block as a motion vector predictor. In this case, the neighboring block may include a spatial neighboring block and a temporal neighboring block.

In case of the dependent view, the predictor 350 may perform inter-view prediction. In this case, the predictor 350 may configure the reference picture list by including pictures of different views.

For the inter-view prediction, the predictor 350 may derive a disparity vector. The predictor 350 may specify a depth block in a depth view on the basis of the disparity vector, and may perform merge list configuration, an inter-view motion prediction, residual prediction, illumination compensation (IC), view synthesis, or the like.

The disparity vector for the current block may be derived from a depth value by using a camera parameter, or may be derived from a motion vector or disparity vector of a neighboring block in a current or different view. The camera parameter may be signaled from the encoding device.

When the merge mode is applied to the current block of the dependent view, the predictor 350 may add, to the merging candidate list, an IvMC corresponding to temporal motion information of a reference view, an IvDC corresponding to a disparity vector, a shifted IvMC derived by a shift of a disparity vector, a texture merging candidate (T) derived from a corresponding texture picture when a current block is a block on a depth map, a disparity derived merging candidate (D) derived by using a disparity from the texture merging candidate, a view synthesis prediction candidate (VSP) derived on the basis of view synthesis, or the like.

In this case, the number of candidates included in the merging candidate list to be applied to the dependent view may be limited to a specific value.

Further, the predictor 350 may predict the motion vector of the current block on the basis of the disparity vector by applying the inter-view motion vector prediction. In this case, the predictor 350 may use a block in a reference view specified by the disparity vector as a reference block. The predictor 350 may use the motion vector of the reference block as a candidate motion parameter or a motion vector predictor candidate of the current block, and may use the disparity vector as a candidate vector for disparity compensated prediction (DCP).

The adder 360 may add the residual sample and the prediction sample to reconstruct the current block or the current picture. The adder 360 may add the residual sample and the prediction sample in unit of blocks to reconstruct the current picture. When the skip mode is applied, a residual is not transmitted, and thus the prediction sample may be a reconstruction sample. Although it is described herein that the adder 360 is configured separately, the adder 360 may be a part of the predictor 350.

The filter 370 may apply de-blocking filtering and/or a sample adaptive offset to the reconstructed picture. In this case, the sample adaptive offset may be applied in unit of samples, and may be applied after de-blocking filtering.

The memory 380 may store a reconstructed picture and information required in decoding. For example, the memory 380 may store pictures used in inter prediction/inter-view prediction. In this case, pictures used in the inter prediction/inter-view prediction may be designated by a reference picture set or a reference picture list. The reconstructed picture may be used as a reference picture for a different picture.

Further, the memory 380 may output the reconstructed picture according to an output order. Although not shown, an output unit may display a plurality of different views to reproduce a 3D image.

Although it is described in the example of FIG. 3 that an independent view and a dependent view are decoded in one decoding device, this is for exemplary purposes only, and the present invention is not limited thereto. For example, each decoding device may operate for each view, and an internal module (for example, a prediction module) may be provided in association with each view in one decoding device.

Multi-view video coding may perform coding on a current picture by using decoding data of a different view belonging to the same access unit (AU) as the current picture to increase video coding efficiency for the current view.

In the multi-view video coding, views may be coded in unit of AU, and pictures may be coded in unit of views. Coding is performed between views according to a determined order. A view which can be coded without a reference of another view may be called a base view or an independent view. Further, a view which can be coded with reference to an independent view or another view after the independent view is coded may be called a dependent view or an extended view. Further, if the current view is a dependent view, a view used as a reference in coding of the current view may be called a reference view. Herein, coding of a view includes coding of a texture picture, a depth map, or the like belonging to the view.

In the inter-view motion prediction procedure, a corresponding block in a reference view which is different from the current view can be found based on a disparity vector, and motion information of the corresponding block can be derived as motion information of a current block. For example, the motion information of the corresponding block can be used as an inter-view merge candidate (IvMC), and the inter-view merge candidate can be used for deriving of a prediction sample of the current block.

Meanwhile, in the multi-view video coding, a residual prediction may be performed by using residual correlation between views in order to enhance coding efficiency for a residual signal. That is, in the multi-view video coding, not only the intra/inter prediction, the inter-view prediction but also the residual prediction may be performed for the current block. The residual prediction may be referred to as advanced residual prediction (ARP). In a procedure of the residual prediction, a corresponding block in a reference view which is different from the current view can be found based on a disparity vector, and a residual prediction sample may be generated by using a different reference block derived based on the corresponding block.

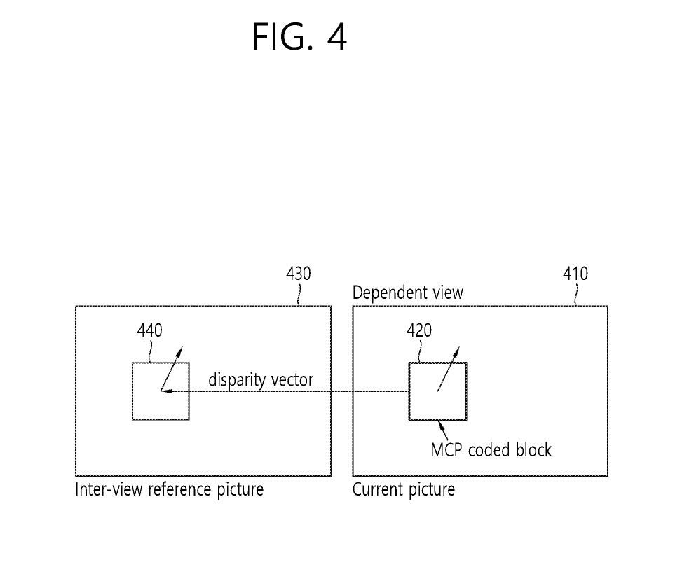

FIG. 4 briefly illustrates an inter-view motion prediction scheme.

Referring to FIG. 4, it is assumed that coding (encoding/decoding) is performed on a current block 420 in a current picture 410. Herein, the current picture 410 may be a depth picture. In addition, herein, the current block 420 may be a prediction block, and may be a block which is coded based on MCP. Herein, a method of performing prediction by referring to pictures having the same view ID is called motion compensated prediction (MCP), and a method of performing prediction by referring to pictures having different view IDs in the same AU is called disparity compensated prediction (DCP).

In case of applying inter-view motion prediction, motion information of the current block 420 may be derived on the basis of motion information of a corresponding block 440 in an inter-view reference picture 430. The corresponding block 440 may be derived based on the disparity vector as described above.

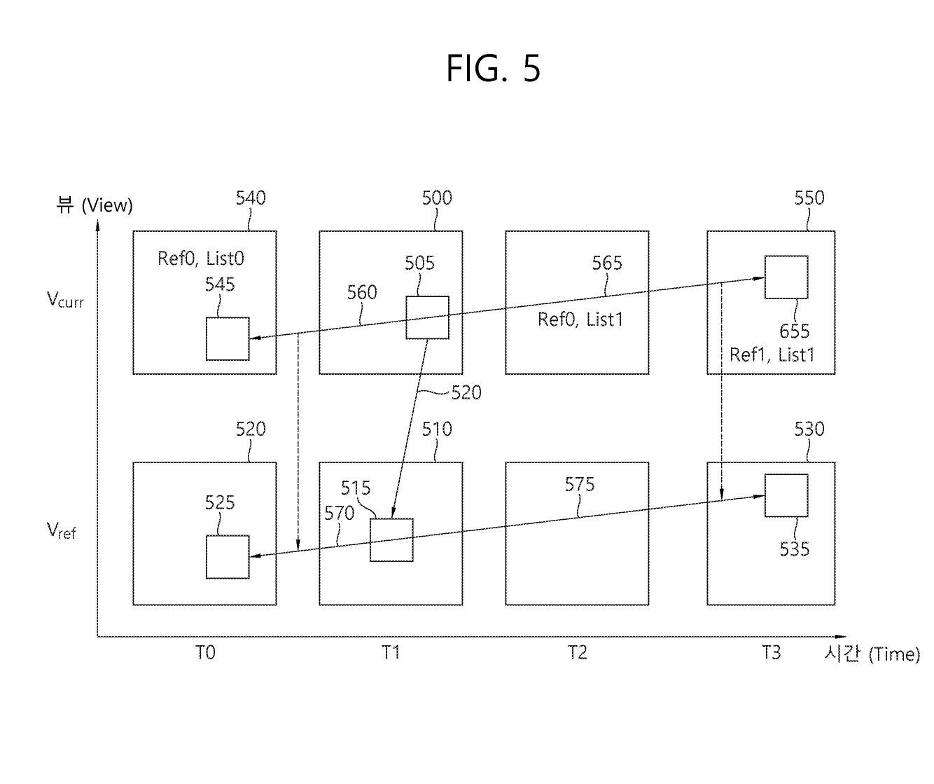

FIG. 5 briefly illustrates a residual prediction scheme.

Referring to FIG. 5, if residual prediction of a current block 505 is performed in a current picture 500 in a current view Vcurr, reference blocks (reference samples) used for the residual prediction of the current block 505 may be derived, and residual prediction samples for the current block 505 may be generated on the basis of residuals of the derived reference blocks.

Herein, the reference blocks for residual prediction may vary depending on whether it is temporal residual prediction (1) or inter-view residual prediction (2).

First, a temporal residual prediction scheme is described.

In case of applying the temporal residual prediction scheme, first, a predictor derives a corresponding block 515 in a reference view Vref corresponding to the current block 505.

The corresponding block 515 may be derived from a picture 510 belonging to the reference view of the current block 505 among pictures in the same AU as the current block 505. A position of the corresponding block 515 may be specified by using a disparity vector 520 in the picture 510 belonging to the reference view.

In this case, the corresponding block 515 may be used as a first reference block (a residual prediction block rpBlock or rpSamp) for residual prediction of the current block 505.

Next, the predictor derives a reference picture 520 or 530 of the corresponding block 515 in the reference view, and derives a reference block 525 or 535 from the reference picture 520 or 530 of the derived corresponding block 515.

In this case, the reference block 525 or 535 may be used as a second reference block (a residual prediction reference block rpRefBlock or rpRefSamples) for residual prediction of the current block 505.

The reference picture 520 or 530 of the corresponding block 515 may be a selected picture having the same POC value as a reference picture 540 or 550 of the current block 505 in the current view, or may be a reference picture in a reference picture list used for residual prediction of the current block 505.

The reference block 525 or 535 of the corresponding block 515 may be specified by performing motion compensation by the use of motion information of the current block 505, for example, a motion vector 560 or 565 of the current block 505, in the reference picture 520 or 530 of the corresponding block 515.

Herein, the reference picture 540 of the current block 505 may be a picture which can be referred to in a forward direction L0 in the inter-prediction, and may be, for example, a picture specified by a reference picture index Ref0 in a reference picture list L0.

The reference picture 550 of the current block 505 may be a picture which can be referred to in a backward direction in the inter-prediction, and may be, for example, a picture which is specified by a reference picture index Ref1 in a reference picture list L1.

The predictor may use a difference between a first reference block reBlock and a second reference block rpRefBlock, which is derived for residual prediction as described above, as a residual prediction sample value of the current block 505. For example, a difference value obtained by subtracting a sample value of the reference block 525 or 535 from a sample value of a corresponding block 515 may be derived as the residual prediction sample value of the current block 505.

In this case, a weighting factor may be applied to the residual prediction sample value of the current block 505. The weighting factor may be transmitted from an encoder to a decoder. For example, the weighting factor may be called iv_res_pred_weight_idx.

For example, the weighting factor may be one of values of 0, 0.5, and 1. The weighting factor 0 may indicate that residual prediction is not applied. Index information indicating which weighting factor will be applied may be transmitted from the encoder to the decoder on a block basis.

Next, an inter-view residual prediction scheme will be described. For example, the inter-view residual prediction scheme may be applied when a current block is predicted from an inter-view reference picture.

When the inter-view residual prediction scheme is applied, a predictor derives the reference picture 540 or 550 in a current view, and derives a reference block 545 or 555 in the reference picture 540 or 550. For example, the predictor may derive the reference block 545 or 555 in the reference picture 540 or 550 on the basis of a derived temporal motion vector of the corresponding block 515.

In this case, the reference block 545 or 555 may be used as a first reference block (a residual prediction block rpBlock or rpSamp) for residual prediction of the current block 505.

Next, the predictor derives the corresponding block 515 in a reference view corresponding to the current block 505.

As described above, the corresponding block 515 may be derived from the picture 510 belonging to the reference view of the current block 505 among pictures in the same AU as the current block 505. In this case, a position of the corresponding block 515 may be specified by using the disparity vector 520 of the current block 505 in the picture 510 of the reference view.

Next, the predictor may derive the reference picture 520 or 530 of the corresponding block 515 on the basis of a (temporal) motion vector and reference picture index of the corresponding block 515, and may derive the reference block 525 or 535 from the reference picture 520 or 530 of the corresponding block 515.

In this case, the reference block 525 or 535 may be used as a second reference block (a residual prediction reference block rpRefBlock or rpRefSamples) for residual prediction of the current block 505.

The reference picture 520 or 530 of the corresponding block 515 may be a selected picture having the same POC value as the reference picture 540 or 550 of the current block 505 in the current view, or may be a reference picture in a reference picture list for a reference view used for residual prediction of the current block 505.

Next, the predictor may use a difference between a first reference block reBlock and a second reference block rpRefBlock, which is derived for residual prediction as described above, as a residual prediction sample value of the current block 505. For example, a value obtained by subtracting a sample value of the reference block 525 or 535 in a reference view from the sample value of the reference block 545 or 555 in a current view may be derived as the residual prediction sample value of the current block 505. In this case, as described above, a weighting factor may be applied to the residual prediction sample value of the current block 505.

As described above, for example, the weighting factor may be one of values of 0, 0.5, and 1. The weighting factor 0 may indicate that residual prediction is not applied. Index information indicating which weighting factor will be applied may be transmitted on a block basis.

As described above, in a procedure such as inter-view motion prediction and residual prediction or the like, a corresponding block of a current block is derived on a reference picture of a reference view by using a disparity vector, and motion information (e.g., a motion vector) for the corresponding block is used. Herein, the motion vector includes a temporal motion vector. However, the position of the corresponding block may not exactly correspond to any prediction block on the reference picture of the reference view, and storing of motion information of all prediction blocks in the reference picture of the reference view for the coding of the current block is a significant burden on a buffer load of an encoder and a decoder.

To solve this problem, motion information must be compressed.

In case of motion information compression for 2D video, motion information of a prediction unit (PU) to be currently coded may be derived directly from motion information of a corresponding block temporally previously coded, or may be used as a prediction value. Therefore, even if coding and decoding for one frame (or picture) are finished, the motion information of blocks in the frame may be used for coding and decoding of a next frame or picture. In this case, the motion information of blocks of a previous frame may be stored in a buffer (or memory) by being compressed with a 1/4 or 1/16 rate.

However, in case of motion information compression for 3D video having a multi-view, frames of different views in an AU having the same time instance as the current frame are highly correlated with the current frame, and thus the frames of the different views in the AU may be referred to for coding of the current frame more than a temporally previous frame of the same view. That is, when performing coding of the current frame, the motion information used in the frames of the different views in the same AU may be used relatively more than the motion information of temporally previous frames of the same view.

Therefore, there is a need to maintain motion information more precisely for the frames in the AU than temporally previous frames. For example, if the motion information of the previous frame is compressed with a 1/16 rate, the motion information of the frame in the AU may be compressed with a 1/4 or 1/8 rate.

For example, if compression is performed with a 1/4 rate, motion information of a top-left 4×4 block in each 8×8 block unit may be used as a representative motion vector for four 4×4 blocks in the 8×8 block. Similarly, in case of performing compression with a 1/16 rate, motion information of the top-left 4×4 block in each 16×16 block unit may be used as a representative motion vector for 16 4×4 blocks in the 16×16 block.

In general, a motion information compression technique has a greater advantage when implemented in hardware than when implemented in software, as a method for reducing a buffer size and a memory bandwidth. For software, an amount of computation for compressing motion information may be more problematic than an advantage obtained by reducing the buffer size and the memory bandwidth.

Accordingly, the present invention proposes a method of deriving effective and precise compressed motion information without compression of physical motion information in software implementation.

In case of 3D video, as described above, in a procedure such as inter-view motion prediction and residual prediction or the like, a corresponding block of a current block is derived on a reference picture of a reference view by using a disparity vector, and uses motion information (e.g., a motion vector) for the corresponding block. In this case, a position of the corresponding block may not be aligned to a 4×4 block grid which is a minimum block unit.

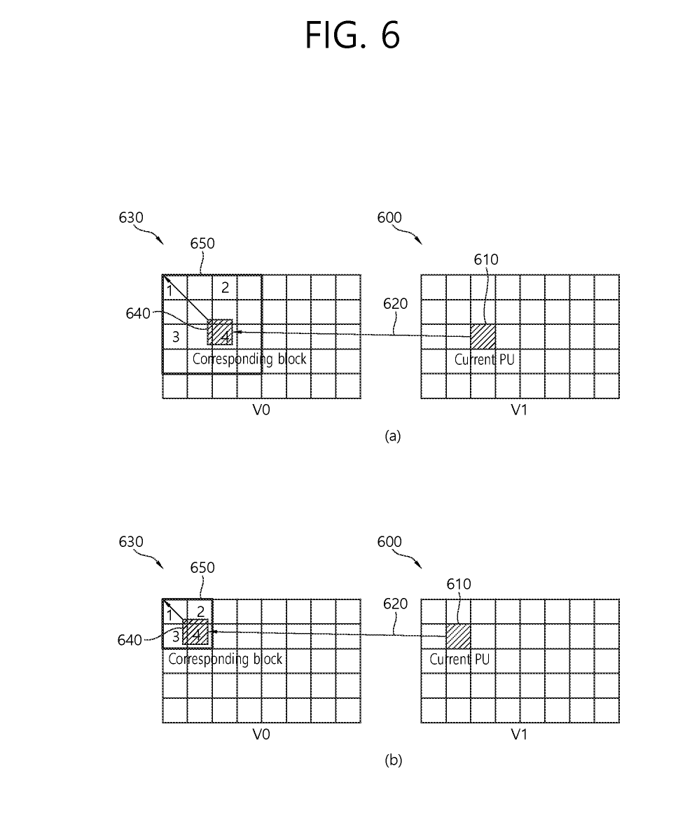

FIG. 6 briefly illustrates a positional relation between a current block and a corresponding block. In FIG. 6, pictures are expressed for example as a 4×4 block grid.

Referring to FIG. 6, a current picture 600 is a picture on a view V1, and a reference picture 630 is a picture on a view V0. A corresponding block 640 may be derived by using a current block 610 on the reference picture 630 and a disparity vector 620. Herein, the corresponding block 640 may be located in several blocks in an overlapping manner, and a criterion for deriving motion information for the corresponding block 640 must be defined by considering motion information compression.

For example, a (prediction) block which covers a position of a reference sample may be determined as a representative block, and motion information of the representative block may be determined as motion information for the corresponding block 640. Herein, the position of the reference sample may be specified as a top-left position of a block 1 of FIG. 6, and the representative block may be the block 1. The position of the reference sample may be determined or calculated on the basis of a position of a corresponding sample, and the position of the corresponding sample may be derived as a center position or top-left position of the corresponding block determined based on the disparity vector and the position of the current block 610. If each of a breadth (width) and length (height) of the corresponding block is constructed of an even number of samples, four samples may face each other at a center point of the corresponding block, and in this case, among the four samples in the center, a position of a bottom-right sample may be determined as the center point. The position of the current block 610 may indicate the top-left position of the current block 610.

For example, if motion information is compressed in unit of 16×16 or 8×8 and if the 16×16 or 8×8 unit block is defined as a motion compression unit block, the position of the reference sample may be configured as a top-left sample position of the motion compression unit block including the corresponding sample. In this case, if the corresponding sample is located in the motion compression unit block, the position of the representative sample may be configured as the top-left sample position of the motion compression unit block irrespective of detailed positions of the corresponding sample and the corresponding block. If the motion compression unit block has an 8×8 size, the representative block may have a 4×4 size.

In addition, for example, the position of the reference sample may be derived by performing a shift operation based on the position of the corresponding sample. Herein, the shift operation includes an arithmetic right shift (>>) and an arithmetic left shift (<<). More specifically, for example, the position of the reference sample may be determined based on the following equation.

xRef=Clip3(0,pic_width_in_luma_samples−1,(xRefFull>>3)<<3),

yRef=Clip3(0,pic_height_in_luma_samples−1,(yRefFull>>3)<<3) [Equation 1]

Herein, xRef and yRef respectively indicate x-coordinate and y-coordinate of the position of the corresponding sample, xRefFull and yRefFull respectively indicate x-coordinate and y-coordinate of the position of the corresponding sample, pic_width_in_luma_samples indicates a width of a picture based on luma samples, and pic_height_in_luma_samples indicates a height of the picture based on the luma samples. Herein, the picture may include a current picture or may include a reference picture. Alternatively, if the current picture and the reference picture are configured to have the same width and height, the picture may include the current picture and the reference picture. Herein, it is apparent that a Clip3 operation may be expressed by the following equation 2.

$$Clip 3 ( x , y , z ) = \{ \begin{matrix}x ; & z < x \\ y ; & z > y \\ z ; & otherwise\end{matrix} \qquad [ Equation 2 ]$$

Meanwhile, in another example, a (prediction) block in which the corresponding block overlaps the most may be determined as a representative block. In this case, the representative block may be a block 4 of FIG. 6.

The motion information compression method according to the aforementioned present invention may be performed by the video encoding device of FIG. 2 and may be performed by the video decoding device of FIG. 3.

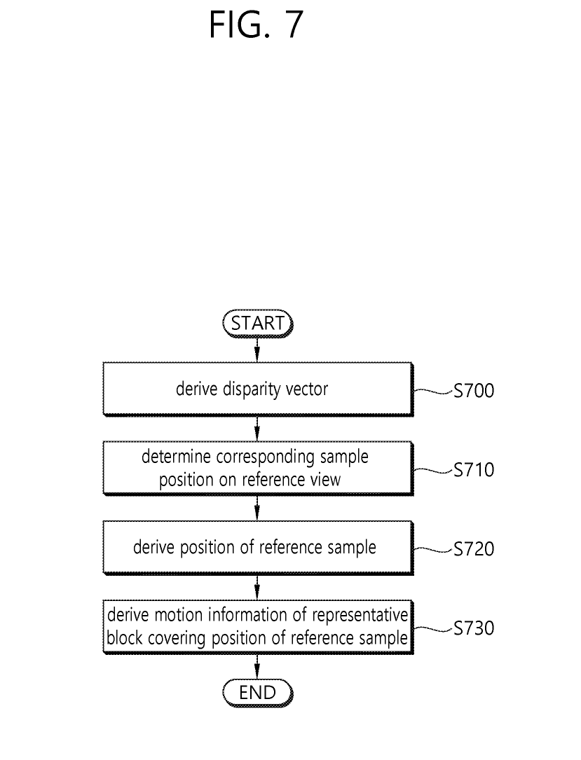

FIG. 7 is a flowchart briefly showing a 3D video coding method according to an embodiment of the present invention. The following description is based on a decoding device.

Referring to FIG. 7, the decoding device derives a disparity vector for a current block (S700). The disparity vector may be derived from a depth value by using a camera parameter, or may be derived from a motion vector or disparity vector of a neighboring block in a current or different view. The disparity vector may be derived based on a spatial or temporal neighboring block of the current block. In this case, the neighboring block may be coded based on disparity compensated prediction (DCP). For example, a picture to which the current block belongs is a texture picture, and the disparity vector derived from the neighboring block may be called a disparity vector from neighboring blocks (NBDV).

Further, the disparity vector may be derived based on the reference view and a specific depth value. The specific value may be a middle value of a depth value range.

Although not shown, the decoding device may receive video information from the encoding device through a bit-stream. The video information may include block split information, prediction mode information, residual information, and syntax element values for reconstructing the current block. The bit-stream may be transmitted from the encoding device to the decoding device through a network or storage medium.

The decoding device determines a corresponding sample position on the reference view based on the disparity vector (S710). For example, a position of the corresponding sample may be derived as a top-left position of a corresponding block determined based on the position of the current block and the disparity vector. For another example, the position of the corresponding sample may be derived as a center position of the corresponding block. Herein, the center position may indicate a position of a bottom-right sample among four samples in the center of the corresponding block.

The decoding device derives a position of a reference sample based on the position of the corresponding sample (S720).

For example, the position of the reference sample may be a top-left sample position of a motion compression unit block including the corresponding sample. The motion compression unit block may have an 8×8 size.

For another example, the position of the reference sample may be derived by performing a shift operation based on the position of the corresponding sample. More specifically, for example, the position of the reference sample may be determined based on the above equation 1.

The decoding device derives motion information of a representative block which covers the position of the reference sample (S730). The representative block may be a prediction block which covers the position of the reference sample. If the motion compression unit block has an 8×8 size, the representative block may have a 4×4 size.

The decoding device may derive IvMC for the current block based on the derived motion information. That is, the derived motion information may be used as the IvMC for the current block, and the decoding device may generate a prediction sample (or a sample array) for the current block based on the IvMC and add a residual sample (or a sample array) to generate a reconstructed sample (picture).

Meanwhile, the decoding device may perform residual prediction based on the derived motion information. More specifically, for example, the decoding device may derive a first reference block on the current view based on a temporal motion vector for a corresponding block on a reference view derived based on the disparity vector, and may derive a second reference block on the reference view based on a temporal motion vector for the corresponding block. The decoding device may generate a (residual) prediction sample (or sample array) of the current block based on the first reference block and the second reference block. The temporal motion vector for the corresponding block may be derived based on the motion information of the prediction block which covers the position of the reference sample. In this case, the motion information of the prediction block may include a motion vector, and the motion vector may be used as the temporal motion vector. Herein, the residual prediction may be inter-view residual prediction. The decoding device may generate a reconstructed sample (picture) based on a (residual) prediction sample (or sample array) of the current block. In this case, the decoding device may optionally add the residual sample (or sample array) to the (residual) prediction sample (or sample array to generate the reconstructed sample (picture).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation, and do not intend to limit technical scopes of the present invention. Therefore, the scope of the invention should be defined by the appended claims.

When the above-described embodiments are implemented in software in the present invention, the above-described scheme may be implemented using a module (process or function) which performs the above function. The module may be stored in the memory and executed by the processor. The memory may be disposed to the processor internally or externally and connected to the processor using a variety of well-known means.

What is claimed is:

1. A 3 dimensional (3D) video decoding method comprising:
deriving a disparity vector for a current block;
deriving a position of a corresponding sample on a reference view on the basis of the disparity vector;
deriving a position of a reference sample on the basis of the position of the corresponding sample; and
deriving motion information of a prediction block which covers the position of the reference sample.

2. The 3D video decoding method of claim 1, further comprising performing residual prediction on the current block on the basis of the derived motion information.

3. The 3D video decoding method of claim 2, wherein the performing of the residual prediction comprises:
deriving a first reference block on the current view on the basis of a temporal motion vector regarding the corresponding block on the reference view derived based on the disparity vector;
deriving a second reference block on the reference view on the basis of the temporal motion vector regarding the corresponding block; and
generating a prediction sample of the current block on the basis of the first reference block and the second reference block,
wherein the temporal motion vector for the corresponding block is derived based on the motion information of the prediction block which covers the position of the reference sample.

4. The 3D video decoding method of claim 3, wherein the motion information of the prediction block comprises a motion vector, and the motion vector is used as the temporal motion vector.

5. The 3D video decoding method of claim 2, wherein the residual prediction is inter-view residual prediction.

6. The 3D video decoding method of claim 1, wherein the disparity vector is derived based on a spatial or temporal neighboring block of the current block.

7. The 3D video decoding method of claim 1, wherein the disparity vector is derived based on the reference view and a specific depth value.

8. The 3D video decoding method of claim 1, wherein the position of the corresponding sample is derived as a top-left position of a corresponding block determined based on the position of the current block and the disparity vector.

9. The 3D video decoding method of claim 1, wherein the position of the corresponding sample is derived as a center position of a corresponding block determined based on the position of the current block and the disparity vector.

10. The 3D video decoding method of claim 9, wherein the position of a bottom-right sample among four samples in the center of the corresponding block is derived as the center position.

11. The 3D video decoding method of claim 1, wherein the position of the reference sample is a top-left sample position of a motion compression unit block comprising the corresponding sample.

12. The 3D video decoding method of claim 11, wherein the motion compression unit block has an 8×8 size.

13. The 3D video decoding method of claim 12, wherein the prediction block has a 4×4 size.

14. The 3D video decoding method of claim 1, wherein the position of the reference sample is derived by performing a shift operation based on the position of the corresponding sample.

15. The 3D video decoding method of claim 1, wherein the position of the reference sample is determined based on the following equation:
xRef=Clip3(0,pic_width_in_luma_samples−1,(xRefFull>>3)<<3); and
yRef=Clip3(0,pic_height_in_luma_samples−1,(yRefFull>>3)<<3),
where xRef and yRef respectively indicate x-coordinate and y-coordinate of the position of the corresponding sample, xRefFull and yRefFull respectively indicate x-coordinate and y-coordinate of the position of the corresponding sample, pic_width_in_luma_samples indicates a width of a picture based on luma samples, and pic_height_in_luma_samples indicates a height of the picture based on the luma samples.
